(19) United States
(12) Patent Application Publication
(10) Pub. No.: US 2004/0073679 A1
(43) Pub. Date: Apr. 15, 2004

(54) Global unique identification of subscriber

(76) Inventors: John A. Martens, Dellwood, MN (US); John G. Shudy, Minneapolis, MN (US)

Correspondence Address: Mark A. Litman & Associates, P.A., York Business Center, Suite 205, 3209 West 76th St., Edina, MN, 55435, US

(21) Appl. No.: 10/236,208

(22) Filed: Sep. 5, 2002

(51) Int. Cl. G06F 15/16

(52) U.S. Cl. 709/227; 709/245

(57) ABSTRACT

A process links computers through a service. A user mechanically reads coded information, such as information from a bar code. Each bar code provides information unique to a service subscriber with fewer than or equal to 36 characters being read. The equal to or fewer than 36 characters can activate a distal address to access information relating to that specific subscriber, the service connecting the user to that address; and provide a compilation of information on the subscriber to the user upon execution of software reading the fewer than or equal to 36 characters.

### BACKGROUND OF THE INVENTION

1. Field of the Invention

The present invention relates to methods of reading symbols to access downloadable information, recordable information, and specifically downloadable addresses and summary information relating to a subscriber of a service wherein the symbols represent global identifiers unique to each subscriber. The symbols (e.g., in the form of a mechanically readable code, especially a bar code and especially a code or bar code with a specifically limited number of characters) may be scanned, and the scanned information used to access a website or central processing station where information specific to the symbols scanned may be accessed and/or downloaded.

2. Background of the Art

The use of computers to store and access information has become an essential part of almost every facet of business and enterprise around the world. Two elements of use of the computer that are corresponding benefits and limitations on the use of information from computers are the speed with which information can be accessed and the length of time needed to place accurate information onto an accessible data base.

The use of computer stored lists for customers, vendors, contacts, friends and the like has become a very important element in data storage for commercial and private use. Data input must be accurate to be useful, and must be complete for it to be used with confidence. One of the most annoying problems in the use of addresses, both web addresses and business addresses is the presence of errors that can misdirect or fail to direct intended contact. An error of a single character in web addresses will always cause misdirection of electronic messages.

Bar codes and other visually scannable systems, as well as alphanumeric identifiers, have been used to provide information that can be sent over the network or stored on computers to identify products or certain information that is desired to be readily accessible. The most familiar use of such bar code information is on products, where scanning identifies the product and its price. By such an identification system, both the stock quantities of the item, the through rate of the item and the cost being charged for the item can be immediately transmitted to a host computer and/or displayed on a cash register. This greatly simplifies inventory control and outlet pricing. Much more sophisticated and inter-business applications of scanned information have been considered and implemented.

U.S. Pat. No. 6,012,102 describes a simplified method of accessing data resources on data communications networks by encoding data resource identifiers into a machine-readable printed symbol which can be scanned into a computer-based data communications terminal. The machine-readable printed symbol can be a bar code or in a form obtainable with any other printed encoding technology which encodes digital information in printed form so that it can be electronically read. Once the symbolic representation of the data resource specifier is read into the computer, software running on the computer can use a data resource identifier to access internet resources. Various features are directed to compressing the size of the data resource identifier to fit within a short symbol such as a bar code on a business card.

U.S. Pat. No. 6,377,986 describes a method for controlling a computer wherein one or more remote locations disposed on a network are accessed in response to scanning an optical code. A first computer disposed on the network connects to a scanner for scanning the optical code of a product by a user. The scanner is uniquely identified with a scanner distributor by a scanner identification number. A second computer disposed on the network is accessed in response to the user scanning the optical code with the scanner, wherein a lookup operation is performed at the second computer to match the scanner identification number with the scanner distributor to obtain remote routing information of the one or remote locations. The remote routing information is returned from the second computer to the first computer in order to access the one or more remote locations disposed on the network. The one or more remote locations are accessed to return remote information to the first computer for presentation.

U.S. Pat. No. 6,321,992 describes a Web-based package routing, tracking and delivering system and method that uses URL/ZIP-CODE encoded bar code symbols on parcels and packages. The system comprises one or more Routing, Tracking and Delivery (RTD) Internet Server Subsystems connected to the Internet infrastructure and updated at any instant of time with package tracking information. A Package Log-In/Shipping Subsystem is located at each shipping location and connected to the RTD Internet Server by way of the Internet infrastructure. A Package Routing Subsystem is located at a hub station and connected to the RTD Internet Server by way of the Internet infrastructure. A Portable Package Delivery Subsystem is carried by each package delivery person, and connected to the RTD Internet Server by way of the Internet infrastructure communication link. At each remote hub station within the system, the URL/ZIP-CODE encoded bar code symbol is automatically scanned by way of the Internet infrastructure; the encoded destination Zip Code is locally recovered and used to route the package at the hub station; and the locally recovered URL is used to access the RTD Internet Server and update the location of the package within the system. The Portable Package Delivery Subsystem is used to read the URL/ZIP-CODE encoded bar code symbol near the delivery destination in order to access the RTD Internet Server and display delivery information and the like to facilitate the delivery process.

Data from retrieved symbols can simply be stored in, for example, an electronic “address book” or list of “favorite places” for later use in accessing an Internet resource, for example. Bar codes have been used in the past in the context of TV programming guides (e.g., VCR+Plus®). The bar codes are printed in printed TV guides, include data about programs and viewing times, and are used for automatically programming a VCR (Video Cassette Recorder). VCR+Plus® bar codes, and similar techniques for representing TV programming information are used locally between the scanning apparatus and a TV. Unlike the present inventive technique, however, they do not encode unique resources addresses but, rather, time and channel data which is location dependent (i.e., different geographical locations have different programming based upon the local stations which carry the programming). Further, there is no interaction involved in bar-code television programming; the commands are strictly “one-way”—namely, to turn on the TV or VCR and select a channel at a particular time.

U.S. Pat. No. 4,654,482 describes a system which uses bar codes for identification purposes and for function command purposes for a home ordering system. In this system, orders can be placed from a user's home using the direct dial telephone network. The orders are placed from printed materials such as catalogues, newspaper inserts or other advertising material which carry an item identification bar code adjacent to a description of an item. This bar code is scanned into a processing device at the user's location. The bar code encodes identification data (an item ID number, similar to UPC—Universal Product Code) and transactional information related to the vendor of the item. The processing device is operated by the user depressing switches to invoke desired actions (e.g., send, select) or to provide desired responses (e.g., yes, no, etc.) in response to prompts on a display. These prompts are generated either locally within the processing device or remotely by a vendor's host computer. The vendor's host computer communicates with the processing device over the direct dial telephone network via a modem. In order to make purchases from different merchants, cartridges containing transactional information for various merchants are provided. Alternatively, a fixed memory containing transactional information relating to a number of different merchants can be used. In this case, one or more bar codes can serve to identify the different merchants and, if desired, to provide data associated with the merchants.

### SUMMARY OF THE INVENTION

A business process links a processor (e.g., computer, PDA, card scanner, data reader or telephone) by mechanically or electromechanically reading coded information such as bar codes that are unique to each subscriber to the business process. The encoded information, such as a bar code may have modest character content (such as equal to or fewer than 36 characters, preferably equal to or less than 30 characters), as the bar code used in the practice of the invention preferably is a unique identifier for the subscriber that enables electronic access (e.g., memory accessed or internet accessed) to a directory where that subscriber's information is provided in greater detail. The use of the input (scanned) data over the internet accesses either central files for subscribers or accesses a bridge provider where contact with a site established by the subscriber is provided. The central files or subscriber site will then provide a compilation of information provided by the subscriber. At least certain components of that information may be downloadable into various formats, such as address lists, vendor lists, supplier lists, client bases, purchasers, and the like.

### DETAILED DESCRIPTION OF THE INVENTION

One of the most common features of the Internet is the exchange of electronic mail (E-mail). Many Internet users print E-mail addresses on their business cards along with their telephone and fax numbers. Any Internet user or any subscriber to most major online services (e.g., Compuserve™, America Online™, etc.) can exchange E-mail with any other connected user as long as he knows the other user's Internet E-mail address.

Another major feature of the Internet involves a data exchange facility commonly referred to as “FTP” (for “File Transfer Protocol,” the transfer protocol which governs data exchange) by which users can exchange binary data with any Internet site which supports FTP (FTP site). FTP users can download or upload binary files of any size over the Internet, and can browse through file directories on remote FTP sites. Other Internet FTP-related facilities provide the ability to search for information by content, title, topic, etc. FTP sites and files are identifiable by a special Internet address specifier which identifies the FTP protocol, Internet site and/or file name and location.

The Internet hypertext facility commonly known as the “World Wide Web”, or “www”, has become increasingly popular. The www facility includes inter-linked hypertext documents, known as “web pages”. These documents utilize a hypertext language called “HTML” (Hyper Text Meta (or Markup) Language) and are processed on the Internet according to a Hypertext Transfer Protocol (“HTTP”). Any web page can link (i.e., reference or “point to”) any other web page anywhere on the Internet. As a result, web pages are spread out all over the Internet. Web pages generally provide a “point and click” style of user interface which requires very little user training. As with FTP data resources (files), web pages are identifiable by a special Internet address (known as a Universal Resource Locator, or URL) which identifies the hypertext protocol (e.g., HTTP) for web pages and the Internet site on which the web page is located. Many www sites have a default “home page” or web page which is automatically accessed whenever the site is referenced.

Addresses of resources on the Internet are specified by the URLs which are long character strings composed of a protocol name and an address (or URN—Universal Resource Name), which includes the path to the requested resource. The accepted format is a string of the form “protocol-name://hostname/path”. Occasionally, the protocol may be inferred from operations already being performed. For example, if one is browsing directories on an Internet site for the purpose of downloading, the “ftp://” file transfer protocol is generally assumed. In such cases, many browser programs permit the specification of a resource (e.g., file) by the URN only. Similarly, if one is browsing www pages, it may reasonably be assumed that the “http://” hypertext transfer protocol is in use and should be the default protocol unless otherwise specified. Internet E-mail addresses are “strings” having the general format: “user-name@hostname.genera”.

Given the electronic nature of the Internet, these URL character strings are usually referenced in electronic documents or in printed matter by reproducing the entire string. To access a resource, a user will either electronically copy its associated string (if the URL string is available electronically) to an application (e.g., software program) capable of accessing it, or will manually type it into such an application (if the URL string is printed in a hard copy document).

The minimum knowledge necessary to contact another party via E-mail or to send or receive information via the Internet is an Internet address; either an E-mail address or a URL/URN specifying an FTP or www resource. Unfortunately, these addresses can be very long and difficult to remember. By way of example, a particular web page might be identified by the Internet URL: “http://www.internetxs.com/pub/indices/userinfo/homepage.html”.

In this example, “http://” identifies the hypertext protocol (the two forward slashes ‘//’ are a special delimiter used to separate the protocol name from the rest of the URL), “www” refers to the “world wide web”, “internetxs.com” refers to a host computer at a commercial site, “/pub/indices/userinfo/” identifies a specific directory on the host computer's storage database, and “homepage.html” is a file specifier for a hypertext web page written in HTML. When this URL is given to www processing software (i.e., a “Web Browser”), the hypertext web page is retrieved over the internet and executed for display to the user. It is beyond the scope of this specification to go into the details of Internet, www and FTP protocols and information transfer mechanisms. However, those of ordinary skill in the art already understand and appreciate the underlying principles and mechanisms.

Many Internet sites provide services and information to Internet users via www, FTP, E-mail, and other mechanisms. Many television and radio news departments, movie studios, research laboratories, universities, manufacturers, vendors and a variety of others have publicly-accessible www or FTP sites. It is not uncommon to see or hear a news broadcast refer to an Internet URL by which more information on a story can be obtained. Numerous manufacturers provide technical support and documentation via the Internet, and print their www or FTP addresses in their advertisements and literature.

For the end user, however, the explosion of Internet URLs and E-mail addresses can be somewhat overwhelming. These addresses must be remembered or carried around on a piece of paper, then manually typed into a computer (or other Internet access terminal) or stored in an electronic address book, often by manual insertion off a keyboard. This process is cumbersome, error-prone, and can be frustrating for the user.

In the present invention, a bar code unique to a service subscriber is scanned to provide internet access to information on that subscriber. The information may be scanned or manually entered to provide immediate access or to be stored for later access or later transfer and access to a permanent data base. The scanned information may link with a computer (preferably with specialized software embedded in a processor or the computer). The scanned information is unique to the service subscriber, and may be provided with as few as thirty or fewer characters. The characters activate an address for providing information relating to the specific service subscriber, preferably connecting the user to a central file address, router to that address, or directly to that address. Upon accessing the address, various levels of information regarding that service subscriber may be accessed and at least some information downloaded. In a preferred embodiment, additional information or non-active trailer data may be associated with the scanned information to amplify or enhance information personally entered by the user that relates to the service subscriber.

The current subscriber process can be portrayed generically as follows.

Current Subscription Process:

1. The subscribers name is typed into an electrOonic form or electronically readable form (e.g., company, individual or code name)

2. A GUID (Global Unique Identifier) is then created and submitted to a server with the subscriber's name (company, individual and/or code name).

3. Data about the subscriber may now be entered into a management table by the administrator and/or the subscriber.

4. The data may be tailored by the Subscriber and/or the administrator (as a service or as a requirement to maintain data compliance or legal compliance standards).

The GUID may be obtained from an administrator site or other central site under the control of the subscribing service or an agent in a procedure similar to, but not limited to the following approximate sequence or combination of steps. A first step or early step would require typing in or otherwise providing the potential service subscriber's name (company, individual and/or code name or identifier). Upon accessing the administrator site, a unique GUID will be provided to the potential subscriber. The potential subscriber may then enter data onto a management field. This data may be tailored by the subscriber. The GUID comprises alphanumerics and/or symbols (e.g., a bar code having all symbols available on a keyboard and possibly additional symbols). The administrator or subscribing service may be able to indicate approval of the GUID and the subscriber may be able to indicate acceptance of the GUID, although this should not be required. A bar code is generated with proprietary software (at least in part located at the administrator site) that enables scanning of the GUID and subsequent access of the administrator system (or direct contact with the subscriber) upon reading and use of data scanned from the bar code.

The Nature and Options With the GUID

There are at least several options that will be discussed in this text related to generating the GUID. The GUIDs can be generated locally so that they can be distributed without immediate access to a server. This allows distribution by a Palm/Computer, local computer and the like. The GUID can also be generated by the central server, as described earlier. The GUID can be generated taking into account the subscriber's provided information, such as the subscriber's name, address, telephone number, e-mail address, physical address, or any other element of information. The GUID is preferably generated in binary form and then expanded into a subset of ASCII characters which comprises alphanumerics and/or symbols (e.g., a barcode having all symbols available on the keyboard and possibly additional symbols). As long as the software and server can ultimately interpret the bar code into meaningful symbols, the nature of the symbols themselves is not critical to the operation of the program. Standard symbols are desirable from the standpoint of user comfort in viewing symbols that convey meaning to the user.

The preferred standard of operation, but not the exclusive standard that may be used in the practice of the invention represents a binary number of base2 with base89, where 89 is the number of characters in the subset of ASCII. (This could change with whatever design features the service would like to use or with changes in available standards or the selection of other standards available at the present time).

The GUID which is represented by a subset of ASCII characters is displayed digitally with a barcode using the barcode128 standard. This bar code is then the bar code that is unique to the subscriber, contains the GUID for access to the administrative site or for access directly to the subscriber site. Either of these options is within the scope of practice of the invention.

A running scenario of one particular type of use of the system of the invention would assist in providing details on operation and performance of the system. An exemplary system would be for booth vendors at a trade show. Each vendor would subscribe to a service that provides them with a Global Unique Identifier (hereinafter referred to as the “GUID”). That GUID would be provided by the service provider. Each GUID would be provided with a unique value, usually by providing a number of unique text characters (e.g., 50, 40, 36, 32, 30 alphanumeric and/or grammatical characters in text), and these characters may be compressed or digitized or otherwise converted into data that can be provided as a bar code. For example, Microsoft® systems produces a GUID from status information (e.g., date, time, location, order, etc.) so that a unique GUID is always provided, as the status cannot be identical among different requests for a GUID. A central server to provide the GUID would accept only one request at an instance or place them into sequence so that the numbers/characters would be different. The service subscriber would then be provided with a unique bar code for this GUID. This unique bar code would be placed on business cards, scanning sheets, letterhead, products, and the like for access by users. The user would scan the bar code into at least temporary memory, and this bar code would be used to access the service subscriber's information file through the internet. The scan would provide, at a minimum, the internet address to the subscriber's network website with downloadable information, and preferably would also contain one or more of the following compressed information: a) service provider address, b) GUID for the specific service subscriber scanned, c) individual's name, d) corporate name, e) telephone number for direct contact, f) corporate information (product or service number), g) other specified information. This information may be scanned into a portable scanner with memory or may be scanned directly into a computer. The memory associated with the portable scanner should be downloadable into a computer, and multiple GUID's/bar codes should be storable, as on commercially available Symbol Scanner™ CS 1504, Metrologic Model No. IS 4100, Symbol CS 2000, PSC QS200, and the like. That information is tailored by the subscribers to meet individual perceptions of industry needs. The scanner itself may require, and preferably requires specific software to translate, decode, or decrypt information. Encryption is not preferred, and is undesirable to the extent that the system is intended to make the information more accessible.

The scanner may also contain direct or symbolic data information, and may be precoded at manufacture or which can be individually programmed into the scanner memory and added to data scanned in for specific service subscribers. For example, a general contracting manufacturer may have specific subcontracting goals to meet at a trade show. He can print in a specific message to attach to each scanned in GUID, such as 1) die manufacturer, 2) specialty etching, 3) precision polymer molding, 4) coolant supplier, 5) package designer, or 6) general interest. As different vendors are encountered at the trade show, the service subscriber can enter the preprogrammed addendum into the scanned data, saving time in later considering what specific products the particular vendor had. The scanner, or an associated PAD, computer or other device can also add more detailed messages that are either added specifically to the scanned file, attached as a sub-file, or otherwise identified in memory as being related to the particular scanned GUID. For example, as each GUID is scanned into memory, it may be listed in memory as GUID, and the next addendum provided will be listed as ADDENDUM₁ and thereby associated with that specific GUID. When the GUID data is downloaded into computer memory (as from the hand held scanner), the Addendum sub-file will also be transferred, and can be brought up with the GUID data, or when the GUID data is brought up on the computer or notebook, there would be an indication that user-added information is available (e.g., with an icon indicating “ATTACHMENT” or the like).

After storage of the scanned bar code on the scanner, it may be downloaded through any port, such as a USB port, serial port, wedge scanner, or keyboard into the computer. Alternatively, the scanned barcode could be accessed in real time by direct entry on keyboard, or digital entry through the above mentioned ports. The computer may be connected on-line, as by addressing a web site contained in the scanned information, to the service router or directly to the service subscriber website.

Of particular importance in the information scanned in is the fact that upon return to a computer, not only may the data contained in the GUID be downloaded, but also that by going on-line, additional information can be downloaded either from the service site or from the scanned service subscriber site. In effect, the visitor to the trade show may be able to scan in data from 100 or more vendors at the show, storing the GUID (even with personal notes for each vendor), load the information onto a computer, access the individual vendor websites, add information to the computer file, and never have to write or type a single word into data or use minimum manual entry. All information may be dumped into the computer by copying text, images, and the like.

The GUIDs may be provided on business cards, if the visitor or potential client does not have a service subscription. The card can be later used if the visitor later obtains the service or by a subsidiary service that does not need full subscription. For example, the casual user may access subscriber sites through the administrator site for a service fee, with the administrator site providing all essential software on a temporary, lease or loan or single use fee basis. The card may also have a prefix, suffix or separate web address for the service so that a card holder may access the service on a trial basis from a card, with the visitor e-mail address logged into the service system to assure that the service is sampled, not continuously used by the visitor. To effect this, it is desirable that specific enabling software may be required with the use of the GUIDs, so that the information, when scanned, can be converted to appropriate internet addresses and/or signals only upon operation of the software. To use the service, the user must therefore eventually subscribe to the service by leasing or purchasing the enabling software.

In general, each URL-encoded bar code symbol of the present invention can be either a linear (1-D) or 2-D bar code symbol structure of virtually any symbology that allows for the encoding of the ASCII-type information contained within a URL-type information structure, the syntax of which is well known in the art. In the preferred embodiment, the URL-Encoded Bar Code Symbol is realized as a truncated-type bar code symbol of Code or Code Symbology. Preferably, each such bar code symbol is printed above, below or alongside each Web-site URL or its listing in a Web-site guide or directory. In general, the URL-encoded bar code symbol can be of any length. Notably, the advantage of using the truncated bar code symbol structure is that the height of the bars and spaces is relatively short in relation to the length of the bar code, thus allowing the URL-encoded truncated Symbol to be easily printed with each Web-site listing printed on crowded pages of printed Web-site guides and catalogues.

What is claimed:

1. A process for linking computers through a service by a user reading information from a bar code, each bar code providing information unique to a service subscriber with equal to or fewer than 36 characters being read, wherein the equal to or fewer than 36 characters can:
a) activate a distal address to access information relating to that specific subscriber, the service connecting the user to that address; and
b) provide a compilation of information on the subscriber to the user upon execution of software reading the equal to or fewer than 36 characters.

2. The process of claim 1 wherein scanning of the less than or equal to 36 characters is performed with a portable scanner that stores the scanned equal to or less than 36 characters.

3. The process of claim 2 wherein the portable scanner dumps scanned data of equal to or less than 30 characters into a computer and the computer stores the scanned data.

4. The process of claim 3 wherein the computer is then connected on-line and software converts the stored data into an on-line accessible address, communicatively connecting the computer to the on-line accessible address.

5. The process of claim 4 wherein after communicatively connecting the computer to the accessible address, information at the accessible address is viewed on the computer.

6. The process of claim 4 wherein after communicatively connecting the computer to the accessible address, information at the accessible address is stored on the computer.

7. The process of claim 6 wherein the information stored on the computer from the accessible address is subsequently used to communicatively connect the computer to the accessible address.

8. The process of claim 3 wherein the computer is then connected on-line to a service server and software converts the stored data into an on-line accessible address, communicatively connecting the computer to the on-line accessible address through the service server.

9. A process for linking computers through a service by a user reading information from a bar code with fewer than or equal to 36 characters and storing the information on a user computer, each bar code providing information uniquely identifying a service subscriber, wherein the fewer than or equal to 36 characters can:
activate a distal address to access information relating to that specific subscriber.

10. The process of claim 9 wherein activation of the distal address is effected through software that interprets data obtained from the scanning of the bar code.

11. The process of claim 10 wherein the software is located on the user computer.

12. The process of claim 11 wherein at least some of the software is located on the user computer.

13. The process of claim 11 wherein at least some of the software is located on a service server computer.

14. A computer having stored in memory therein a software program that can convert data from a scanned bar code with equal to or fewer than 36 characters into a service subscriber specific including a web address and then the program can communicatively connect the computer to that web address.

15. The computer of claim 14 wherein data from a scanner may comprise stored data that is first stored in memory in a scanner and then downloaded into the computer.

16. The computer in claim 14 wherein communicatively connecting the computer to that address is effected upon specific request from a computer user.

17. The computer in claim 14 wherein communicatively connecting the computer to that address is effected as part of a program sequence upon accessing the computer using converted scanned bar code data.

18. A product that can be used in the process of claim 1, the product having the machine readable compilation of symbols with fewer than or equal to 36 characters that can direct software to identify information on the subscriber to the user upon execution of the software reading the symbols with fewer than or equal to 36 characters.
